(19) United States
(12) Patent Application Publication
(10) Pub. No.: US 2026/0353055 A1
(43) Pub. Date: Nov. 5, 2026

(54) APPARATUS AND METHOD FOR PERFORMING DYNAMIC MODE SWITCHING IN SHORT-RANGE WIRELESS COMMUNICATION SYSTEM

(71) Applicant: LG Electronics Inc., Seoul (KR)

(72) Inventors: Hyeonjae LEE, Seoul (KR); Jongmin KIM, Seoul (KR)

(21) Appl. No.: 19/474,454

(22) PCT Filed: Apr. 11, 2024
(86) PCT No.: PCT/KR2024/004854

§ 371 Date: Oct. 10, 2025

(30) Foreign Application Priority Data
Apr. 11, 2023 (KR) 10-2023-0047662

(51) Int. Cl. H04W 4/80; H04W 80/12; H04W 84/18

(52) U.S. Cl. CPC H04W 4/80; H04W 80/12; H04W 84/18

(57) ABSTRACT

The present disclosure relates to an apparatus and a method for performing dynamic mode switching in a short-range wireless communication system. In particular, the present disclosure relates to an apparatus and a method for performing dynamic mode switching between a gaming mode (hybrid mode) and an office mode (default mode) through a user interface input of a host device or a specific button input of a peripheral device.

### TECHNICAL FIELD

The present disclosure relates to an apparatus and a method for performing dynamic mode switching in a short-range wireless communication system. Particularly, the present disclosure relates to an apparatus and a method for performing dynamic mode switching between a Gamming mode (Hybrid mode) and an Office mode (Default mode) through a User Interface input of a Host Device or a specific Button input of a Peripheral Device.

### BACKGROUND ART

In conventional Bluetooth specifications, a reason for selecting a limited number of retransmissions is as follows.

In the case of gaming use, there is no retransmission that meets a requirement at a very short latency. The limited retransmissions (controlled by an HID host) can have zero or more retransmissions, thus allowing a lowest latency and providing some additional robustness at a higher latency. A stream date has a “previously used” tag, but “reliable” transmission cannot be used.

In the case of office use, a “reliable” transmission means is required for an expected user experience. Specifications are needed to enable some devices (e.g., a keyboard and a mouse) to switch between a “gaming” report and an “office” report.

Advantages of a dynamic switching mode for a game mode and an office mode are as follows. In most cases, a low latency is not required. Many users never use this application and never miss the application. The low latency (with limited stability) is not applied to applications other than games. In particular, a device such as the keyboard or the mouse must operate in both modes.

Although specification and implementation complexity is higher, only a “standard” GATT-based protocol is required. Advantages of a static mode for the game mode and the office mode are as follows. The static mode is simpler to implement than the dynamic switching mode, but the static mode does not handle devices used for both the game application and the “office” application. In a new profile, the static mode can be used. Instead, since a profile can be switched in the application, complexity can be pushed “elsewhere”

### DISCLOSURE

### Technical Problem

In order to solve the above-described problem, the present disclosure provides an apparatus and a method for performing dynamic mode switching in a short-range wireless communication system.

The present disclosure provides an apparatus and a method for performing dynamic mode switching between a Gamming mode (Hybrid mode) and an Office mode (Default mode) through a User Interface input of a Host Device or a specific Button input of a Peripheral Device.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### Technical Solution

According to various embodiments of the present disclosure, provided is an operation method of a first device in a short-range wireless communication system, in which the first device includes: a first processor corresponding to a host stack; a second processor corresponding to a controller stack; a memory; an input device corresponding to a user interface (UI); an output device corresponding to the UI; and a transceiver, and the host stack and the controller stack being connected via a Host Controller Interface (HCI), the method including: receiving a switching input from a default mode to a hybrid mode based on an input of the UE, wherein the first device corresponding to a host and a second device corresponding to a peripheral device are connected through a Generic Attribute Profile (GATT) channel in the default mode; transmitting, to the second device, a first write message based on a write without response, wherein the first write message is related to an Isochronous Channel (ISO) enable instruction; receiving, from the second device, a first notification message based on a notification, wherein the first notification message is related to an ISO enabled indication; performing an ISO enable procedure; and terminating communication with the second device through the GATT channel, and performing communication with the second device through a Connected Isochronous Stream (CIS) channel.

According to various embodiments of the present disclosure, provided is an operation method of a second device in a short-range wireless communication system, in which the second device includes: a first processor corresponding to a host stack; a second processor corresponding to a controller stack; a memory; a specific switch for an input; and a transceiver, and the host stack and the controller are connected via a Host Controller Interface (HCI), the method including: receiving, from a first device, a first write message based on a write without response from a default mode based on an input of a user interface (UI) of the first device, wherein the first device corresponding to a host and the second device corresponding to a peripheral device are connected through a Generic Attribute Profile (GATT) channel, and wherein the first write message is related to an Isochronous Channel (ISO) enable instruction; transmitting, to the first device, a first notification message based on a notification, wherein the first notification message is related to an ISO enabled indication; performing an ISO enable procedure; and terminating communication with the first device through the GATT channel, and performing the communication with the first device through a Connected Isochronous Stream (CIS) channel.

According to various embodiments of the present disclosure, provided is a first device in a short-range wireless communication system, which includes: a first processor corresponding to a host stack, a second processor corresponding to a controller stack; a memory; an input device corresponding to a user interface (UI); an output device corresponding to the UI; and a transceiver, in which the host stack and the controller stack are connected by a Host Controller Interface (HCI), the memory stores instructions for performing operations based on being executed by the first processor and the second processor, and the operations include: receiving a switching input from a default mode to a hybrid mode based on an input of the UI, wherein the first device corresponding to a host and a second device corresponding to a peripheral device are connected through a Generic Attribute Profile (GATT) channel in the default mode; transmitting, to the second device, a first write message based on a write without response, wherein the first write message is related to an Isochronous Channel (ISO) enable instruction; receiving, from the second device, a first notification message based on a notification, wherein the first notification message is related to an ISO enabled indication; performing an ISO enable procedure, and terminating communication with the second device through the GATT channel, and performing communication with the second device through a Connected Isochronous Stream (CIS) channel.

### Advantageous Effects

In order to solve the above-described problem, the present disclosure can provide an apparatus and a method for performing dynamic mode switching in a short-range wireless communication system.

The present disclosure can provide an apparatus and a method for performing dynamic mode switching between a Gamming mode (Hybrid mode) and an Office mode (Default mode) through a User Interface input of a Host Device or a specific Button input of a Peripheral Device.

### DESCRIPTION OF DRAWINGS

The accompanying drawings, which are to provide a further understanding of the present disclosure, can provide embodiments of the present disclosure together with the detailed description. However, technical features of the present disclosure are not limited to specific drawings and features disclosed in the respective drawings may be combined with each other to constitute a new embodiment. Reference numerals in each drawing may refer to structural elements.

FIG. 1 is a schematic view illustrating an example of a wireless communication system using a Bluetooth low energy technology to which the present disclosure is applicable.

FIG. 2 illustrates an example of an internal block diagram of a device capable of implementing methods proposed by the present disclosure.

FIG. 3 illustrates an example of a Bluetooth communication architecture to which methods proposed by the present disclosure may be applied.

FIG. 4 illustrates an example of a structure of a generic attribute profile (GATT) of Bluetooth low energy.

FIG. 5 is a flowchart showing an example of a connection procedure method in Bluetooth low energy technology to which the present disclosure may be applied.

FIG. 6 illustrates an example of a configuration of a signal transmitted between a central device (host device or master device) and a peripheral device (slave device).

FIG. 7 illustrates an example of a configuration of a signal transmitted between a central device (host device or master device) and a peripheral device (slave device).

FIG. 8 illustrates an example of a configuration of a signal transmitted between a central device (host device or master device) and a peripheral device (slave device).

FIG. 9 illustrates an example of a configuration of a signal transmitted between a central device (host device or master device) and a peripheral device (slave device).

FIG. 10 illustrates an example of a configuration of a signal transmitted between a central device (host device or master device) and a peripheral device (slave device).

FIG. 11 illustrates an example of a mode change configuration of a central device (host device or master device) and a peripheral device (slave device) according to various embodiments of the present disclosure.

FIG. 12 illustrates an example of a mode change configuration of a central device (host device or master device) and a peripheral device (slave device) according to various embodiments of the present disclosure.

FIG. 13 illustrates an example of a change sequence to a hybrid mode in a short-range wireless communication system according to various embodiments of the present disclosure.

FIG. 14 illustrates an example of a change sequence to a hybrid mode in the short-range wireless communication system according to various embodiments of the present disclosure.

FIG. 15 illustrates an example of a change sequence to a default mode in the short-range wireless communication system according to various embodiments of the present disclosure.

FIG. 16 illustrates an example of a change sequence to a default mode in the short-range wireless communication system according to various embodiments of the present disclosure.

FIG. 17 illustrates an example of an operation process of a wireless device in the short-range wireless communication system according to various embodiments of the present disclosure.

FIG. 18 illustrates an example of an operation process of a wireless device in the short-range wireless communication system according to various embodiments of the present disclosure.

### MODES FOR DISCLOSURE

In various embodiments of the present disclosure, “A or B” may mean “only A,” “only B,” or “both A and B”. In other words, “A or B” may be interpreted as “A and/or B” in various embodiments of the present disclosure. For example, in various embodiments of the present disclosure. “A, B or C” can mean “only A,” “only B,” “only C.” or “any combination of A, B, and C”.

A slash (/) or a comma used in various embodiments of the present disclosure may mean “and/or”. For example, “A/B” may mean “A and/or B”. Accordingly, “A/B” may mean “only A,” “only B,” or “both A and B”. For example, “A, B, C” may mean “A, B, or C”.

In various embodiments of the present disclosure, “at least one of A and B” may mean “only A,” “only B,” or “both A and B”. Further, in various embodiments of the present disclosure, the expression “at least one of A or B” or “at least one of A and/or B” may be interpreted the same as “at least one of A and B”.

Further, in various embodiments of the present disclosure. “at least one of A, B and C” may mean “only A,” “only B,” “only CU, or “any combination of A, B and C”. Further, in various embodiments of the present disclosure, the expression “at least one of A, B or C” or “at least one of A, B and/or C” may be interpreted the same as “at least one of A, B and C”.

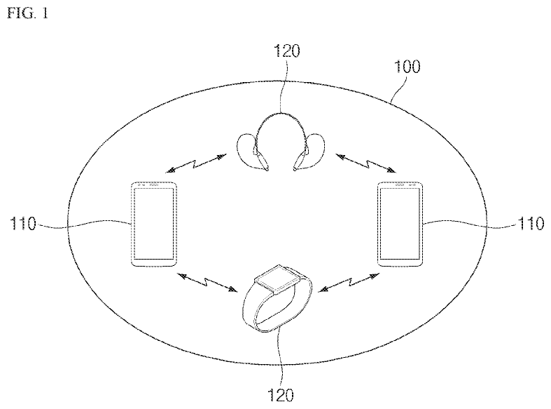

FIG. 1 is a schematic view illustrating an example of a wireless communication system using a Bluetooth low energy technology to which the present disclosure is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a slave, a server, a conductor, a host device, a gateway, a sensing device, a monitoring device, a first device, a second device, etc.

The client device 110 may be expressed as a master device, a master, a client, a member, a sensor device, a sink device, a collector, a third device, a fourth device, etc.

The server device and the client device correspond to main components of the wireless communication system and the wireless communication system may include other components other than the server device and the client device.

The server device refers to a device that receives data from the client device, communicates directly with the client device, and provides data to the client device through a response when receiving a data request from the client device.

Further, the server device sends a notice/notification message and an indication message to the client device in order to provide data information to the client device. In addition, when the server device transmits the indication message to the client device, the server device receives a confirm message corresponding to the indication message from the client device.

Further, the server device may provide the data information to a user through a display unit or receive a request input from the user through a user input interface in the process of transmitting and receiving the notice, indication, and confirm messages to and from the client device.

In addition, the server device may read data from a memory unit or write new data in the corresponding memory unit in the process of transmitting and receiving the message to and from the client device.

Further, one server device may be connected to multiple client devices and may be easily reconnected to the client devices by using bonding information.

The client device 120 refers to a device that requests the data information or data transmission to the server device.

The client device receives the data from the server device through the notice message, the indication message, etc., and when receiving the indication message from the server device, the client device sends the confirm message in response to the indication message.

Similarly, the client device may also provide information to the user through the display unit or receive an input from the user through the user input interface in the process of transmitting and receiving the messages to and from the server device.

In addition, the client device may read data from the memory unit or write new data in the corresponding memory unit in the process of transmitting and receiving the message to and from the server device.

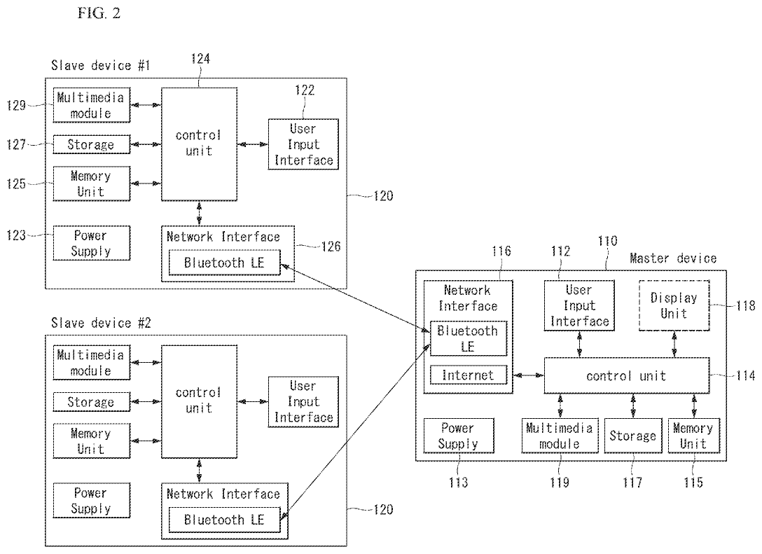

Hardware components such as the display unit, the user input interface, and the memory unit of the server device and the client device will be described in detail in FIG. 2.

Further, the wireless communication system may configure personal area networking (PAN) through Bluetooth technology. As an example, in the wireless communication system, a private piconet between the devices is established to rapidly and safely exchange files, documents, and the like.

FIG. 2 illustrates an example of an internal block diagram of a device capable of implementing methods proposed by the present disclosure.

As shown in FIG. 2, the master device 110 includes a user input interface 112, a power supply unit 113, a control unit 114, a memory unit 115), a network interface including a Bluetooth interface (Network Interface. 116), a storage (Storage, 117), an output unit (Display Unit, 118), and a multimedia module (Multi media Module, 119).

A network interface including the input unit (User Input Interface. 112), the power supply unit (Power Supply Unit, 113), the control unit (Control Unit, 114), the memory (Memory Unit, 115), and a Bluetooth interface (Bluetooth Interface) (Network Interface, 116), storage (Storage, 117), output unit (Display Unit, 118), and multimedia module (Multi media Module, 119) are functionally connected to each other to perform the method proposed in this specification.

In addition, as shown in FIG. 2, the slave devices (#1 and #2) 120 include an input unit (User Input Interface) 122, a power supply unit (Power Supply Unit) 123, a control unit (Control Unit, 124), memory (Memory Unit, 125), network interface (Network Interface, 126) including Bluetooth interface, storage (Storage, 127), output unit (Display Unit, 128), multi media module (Multi media Module, 129).

A network interface including the input unit (User Input Interface, 122), the power supply unit (Power Supply Unit, 123), the control unit (Control Unit, 124), the memory (Memory Unit, 125), and a Bluetooth interface (Bluetooth Interface) (Network Interface, 126), storage (Storage, 127), output unit (Display Unit, 128), and multimedia module (Multi media Module, 129) are functionally connected to each other to perform the method proposed in this specification.

The network interfaces 116 and 126 refer to units (or modules) capable of transmitting requests/responses, commands, notifications, instruction/confirmation messages, etc., or data between devices using Bluetooth technology.

The memories 115 and 125 are units implemented in various types of devices and refer to units in which various types of data are stored. Also, the storages 117 and 127 refer to units that perform a function similar to that of a memory.

The controllers 114 and 124 refer to a module that controls the overall operation of the master device 110 or the slave device 120, requests to transmit a message to a network interface, or controls to process a received message.

The controllers 114 and 124 may include an application-specific integrated circuit (ASIC), another chipset, a logic circuit, and/or a data processing device.

The memories 115 and 125 may include read-only memory (ROM), random access memory (RAM), flash memory, memory card, storage medium, and/or other storage devices.

The memories 115 and 125 may be inside or outside the processors 114 and 124, and may be connected to the processors 114 and 124 by various well-known means.

The output units 118 and 128 refer to modules for providing device status information and message exchange information to users through screens.

The power supply unit (power supply unit, 113, 123) refers to a module that receives external power and internal power under the control of the control unit and supplies power necessary for the operation of each component.

As discussed above, the BLE technology has a small duty cycle and can greatly reduce power consumption through a low data rate.

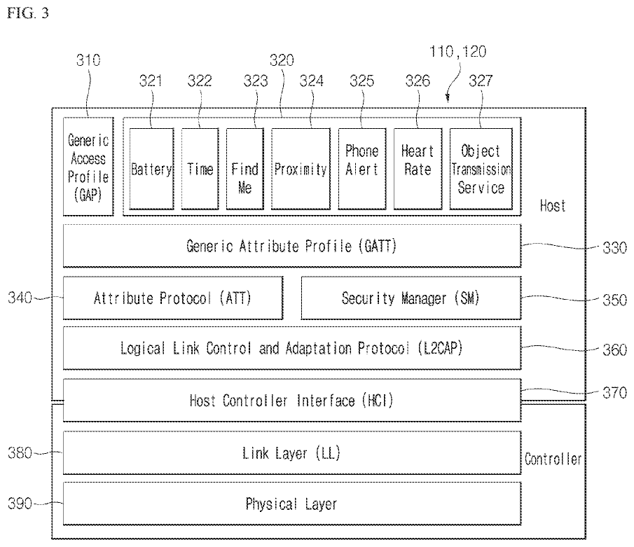

FIG. 3 illustrates an example of a Bluetooth communication architecture to which methods proposed by the present disclosure may be applied.

Specifically, FIG. 3 illustrates an example of an architecture of Bluetooth low energy (LE).

As shown in FIG. 3, the BLE structure includes a controller stack capable of processing a wireless device interface for which timing is critical and a host stack capable of processing high level data.

The controller stack may also be called a controller. In order to avoid confusion with the processor, that is, an internal element of the device described with reference to FIG. 2, however, the controller stack may be preferably used below.

First, the controller stack may be implemented using a communication module which may include a Bluetooth wireless device and a processor module which may include a processing device, such as a microprocessor.

The host stack may be implemented as part of an OS operating on the processor module or as a package instance on an OS.

In some cases, the controller stack and the host stack may operate or may be performed on the same processing device within the processor module.

The host stack includes a generic access profile (GAP) 310, GATT based profiles 320, a generic attribute profile (GATT) 330, an attribute protocol (ATT) 340, a security manager (SM) 350, and a logical link control and adaptation protocol (L2CAP) 360. The host stack is not limited to the aforementioned composition, but may include various protocols and profiles.

The host stack multiplexes various protocols and profiles provided by that Bluetooth disclosure using the L2CAP.

First, the L2CAP 360 provides one bilateral channel for sending data to according to a specific protocol or specific profile.

The L2CAP is capable of multiplexing data between upper layer protocols, segmenting or reassembling packages, and managing multicast data transmission.

BLE uses three fixed channels for respective signaling, a security manager, and an attribute protocol.

BR/EDR uses a dynamic channel and supports a protocol service multiplexer, retransmission, streaming mode.

The SM 350 authenticates a device, which is a protocol for providing a key distribution.

The ATT 340 relies on a server-client structure, which defines rules for a corresponding device for data access. Six message types are defined: Request, Response, Command, Notification, Indication, and Confirmation.

\textcircled{1} Request and Response message: the Request message is used when a client device requests specific information from a server device, and the Response message is used in response to a Request message, which is transmitted from the server device to the client device.

\textcircled{2} Command message: The Command message is transmitted from a client device to a server device in order to indicate a command for a specific operation, but the server device does not send a response to a Command message to the client device.

\textcircled{3} Notification message: A server device sends this message to a client device in order to provide notification of an event, but the client device does not send a confirmation message to the server device in response to a Notification message.

\textcircled{4} Indication and Confirm message: A server device sends this message to a client device in order to provide notification of an event. Unlike in the Notification message, the client device sends a Confirm message to the server device in response to an Indication message.

The generic access profile (GAP) is a layer newly implemented to support the BLE technology, and is used to control the selection of a role for communication between BLE devices and a multi-profile operation.

The GAP is mainly used for device discovery, connection establishment, and security. That is, the GAP defines a method for providing information to a user and also defines the following attribute types.
\textcircled{1} Service: A combination of actions related to data, and it defines the basic operation of a device.
\textcircled{2} Include: Define a relationship between services.
\textcircled{3} Characteristics: A data value used by a service
\textcircled{4} Behavior: A format that may be readable by a computer, which is defined by a Universal Unique Identifier (UUID) and a value type.

The GATT-based profiles are dependent on the GATT and are mainly applied to BLE devices. The GATT-based profiles may include Battery, Time, FindMe, Proximity, Object Delivery Service and so on. More specific descriptions of the GAT-based profiles are as follows.
Battery: A method for exchanging battery information.
Time: A method for exchanging time information.
FindMe: A method for providing an alarm service according to the distance.
Proximity: A method for exchanging battery information.
Time: A method for exchanging time information

The GATT may be used as a protocol by which to describe how the ATT is utilized at the time of composing services. For example, the GATT may be used to define how the ATT profiles are grouped together with services and to describe characteristics associated with the services.

Therefore, the GATT and the ATT describe device statuses and services, and how features are associated with each other and how they are used.

The controller stack includes a physical layer 390, a link layer 380, and a host controller interface 370.

The physical layer 390 (or a wireless transmission and reception module) sends and receives radio signals of 2.4 GHz, and uses GFSK modulation and frequency hopping utilizing 40 RF channels.

The link layer 380 sends or receives Bluetooth packets.

Furthermore, the link layer establishes a connection between devices after performing the advertising and scanning function using three advertising channels, and provides a function of exchanging a maximum of 42 bytes of data packets through 37 data channels.

The host controller interface (HCI) provides an interface between the host stack and the controller stack so that the host stack may provide commands and data to the controller stack and the controller stack may provide events and data to the host stack.

Hereinafter, the procedure of BLE is described briefly.

The BLE procedure includes a device filtering procedure, an advertising procedure, a scanning procedure, a discovering procedure, and a connecting procedure.

### Device Filtering Procedure

The device filtering procedure functions to reduce the number of devices which perform responses to requests, commands, or notification in the controller stack.

All of devices may not need to respond to received requests. Accordingly, the controller stack reduces the number of transmitted requests so that power consumption may be reduced in the BLE controller stack.

An advertising device or a scanning device may perform the device filtering procedure in order to restrict the number of devices which receive advertisement packets, scan requests, or connection requests.

In this case, the advertising device refers to a device which sends an advertisement event, that is, a device which performs advertisement, and is also called an advertiser.

A scanning device refers to a device which performs scanning, that is, a device which sends a scan request.

In the BLE disclosure, if a scanning device receives part of advertisement packets from an advertising device, the scanning device has to send a scan request to the advertising device.

If the transmission of a scan request is not required as the device filtering procedure is used, however, the scanning device may ignore advertisement packets transmitted by an advertising device.

The device filtering procedure may be used even in the connection request procedure. If device filtering is used for the connection request procedure, the need for sending a response to a connection request may be made unnecessary by ignoring the connection request.

### Advertising Procedure

An advertising device performs an advertisement procedure to perform non-directional broadcast using the devices within the range of the advertising device.

In this case, the non-directional broadcast refers to broadcast in all directions rather than broadcast in specific directions.

Unlike the non-directional broadcast, the directional broadcast refers to broadcast in a specific direction. Non-directional broadcast is performed without involving a connection procedure between devices in a listening state (hereinafter referred to as a “listening device”).

The advertising procedure is used to establish a BLE to a nearby initiating device.

In some embodiments, the advertising procedure may be used to provide the periodic broadcast of user data to scanning devices which perform listening through an advertising channel.

In the advertising procedure, all of advertisements (or advertisement events) are broadcasted through an advertising physical channel.

An advertising device may receive a scan request from a listening device which performs a listening operation in order to obtain additional user data from the advertising device. In response to the scan request, the advertising device sends a response to the listening device which has sent the scan request through the same advertising physical channel through which the advertising device has received the scan request.

While broadcast user data sent as part of advertising packets forms dynamic data, scan response data is static for the most part.

An advertising device may receive a connection request from an initiating device through an advertising (or broadcast) physical channel. If the advertising device has used a connectable advertisement event and the initiating device has not been filtered by a filtering procedure, the advertising device stops an advertisement and enters connected mode. The advertising device may resume the advertisement after entering the connected mode.

### Scanning Procedure

A device performing a scan operation, i.e., a scanning device, performs a scanning procedure in order to listen to the non-directional broadcast of user data from advertising devices which use an advertising physical channel.

In order to request additional user data, a scanning device sends a scan request to an advertising device through an advertising physical channel. In response to the scan request, the advertising device includes additional user data requested by the scanning device in a scan response and sends the scan response to the scanning device through the advertising physical channel.

The scanning procedure may be used while a scanning device is connected to another BLE device in a BLE piconet.

If a scanning device receives a broadcast advertising event and stays in initiator mode where a connection request may be initiated, the scanning device may initiate BLE for an advertising device by sending a connection request to the advertising device through an advertising physical channel.

If a scanning device sends a connection request to an advertising device, the scanning device stops the entire scanning for additional broadcast and enters connected mode.

### Discovering Procedure

Devices capable of Bluetooth communication (hereinafter referred to as “Bluetooth devices”) perform an advertising procedure and a scanning procedure in order to discover devices around the Bluetooth devices or devices to be discovered by other devices within a given area.

The discovering procedure is performed in an asymmetric manner. A Bluetooth device searching for another Bluetooth device nearby is called a discovering device, and performs listening in order to search for devices that advertise advertisement events that may be scanned. A Bluetooth device which may be discovered and used by another device is called a discoverable device. A discoverable device actively broadcasts an advertisement event so that other devices may scan the discoverable device through an advertising (or broadcast) physical channel.

Both the discovering device and the discoverable device may already have been connected to other Bluetooth devices in a piconet.

### Connecting Procedure

A connecting procedure is asymmetric. In the connecting procedure, while a particular Bluetooth device performs an advertising procedure, other Bluetooth devices need to perform a scanning procedure.

In other words, the advertising procedure may be a primary task to be performed, and as a result, only one device may respond to an advertisement. After receiving a connectable advertisement event from an advertising device, the connecting procedure may be initiated by sending a connection request to the advertising device through an advertising (or broadcast) physical channel.

Operation statuses defined in the BLE technology, that is, an advertising state, a scanning state, an initiating state, and a connection state, are described briefly below.

### Advertising State

The link layer (LL) enters the advertising state in a command from a host (or stack). If the link layer is in the advertising state, the link layer sends advertising packet data units (PDUs) at advertisement events.

Each advertisement event includes at least one advertising PDU, and the advertising PDU is transmitted through an advertising channel index. Each advertisement event may be previously closed if the advertising PDU is transmitted through each advertising channel index, the advertising PDU is terminated, or the advertising device needs to secure the space in order to perform other functions.

### Scanning State

The link layer enters the scanning state in response to a command from a host (or stack). In the scanning state, the link layer listens to advertising channel indices.

The scanning state supports two types: passive and active scanning. The host determines a scanning type.

No separate time or advertising channel index is defined to perform scanning.

In the scanning state, the link layer listens to an advertising channel index for “scanWindow” duration, scanInterval is defined as the interval between the start points of two consecutive scan windows.

If there is no scheduling collision, the link layer has to perform listening in order to complete all of the scanIntervals of scanWindows as commanded by the host. In each scanWindow, the link layer has to scan other advertising channel indices. The link layer uses all of available advertising channel indices.

In the case of passive scanning, the link layer is unable to send any packet, but only receives packets.

In the case of active scanning, the link layer performs listening to the advertising device to rely on the advertising PDU type by which additional information related to the advertising PDUs and advertising device may be requested.

### Initiating State

The link layer enters the initiating state in response to a command from a host (or stack).

In the initiating state, the link layer performs listening to advertising channel indices.

In the initiating state, the link layer listens to an advertising channel index for “scanWindow” duration.

### Connection State

The link layer enters a connection state when the device performing the connection request, i.e., the initiating device transmits CONNECT_REQ PDU to the advertising device or when the advertising device receives CONNECT_REQ PDU from the initiating device.

After entering the connections state, it is considered that the connection is created. However, it need not be considered so that the connection is established at the time of entering the connections state. An only difference between a newly created connection and the previously established connection is a link layer connection supervision timeout value.

When two devices are connected to each other, two devices play difference roles.

A link layer serving as a master is referred to as the master and a link layer serving as a slave is referred to as the slave. The master controls a timing of a connection event and the connection event refers to a time at which the master and the slave are synchronized.

A packet defined in the Bluetooth interface will be briefly described below. BLE devices use packets defined below.

### Packet Format

The link layer has only one packet format used for both an advertising channel packet and a data channel packet.

Each packet is constituted by four fields, i.e., a preamble, an access address, a PDU, and a CRC.

When one packet is transmitted in an advertising physical channel, the PDU will become an advertising channel PDU and when one packet is transmitted in a data physical channel, the PDU will become a data channel PDU.

### Advertising Channel PDU

The advertising channel PDU includes a 16 bit header and a payload of various sizes.

The PDU type field of an advertising channel included in the header supports PDU types defined in Table 1 below.

TABLE 1

| | | | Permitted PHYs | | |
|---|---|---|---|---|---|
| PDU Type | PDU Name | Channel | LE 1M | LE 2M | LE Coded |
| 0000b | ADV_IND | Primary | ◯ | | |
| | | Advertising | | | |
| 0001b | ADV_DIRECT_IND | Primary | ◯ | | |
| | | Advertising | | | |
| 0010b | ADV_NONCONN_IND | Primary | ◯ | | |
| | | Advertising | | | |
| 0011b | SCAN_REQ | Primary | ◯ | | |
| | | Advertising | | | |
| | AUX_SCAN_REQ | Secondary | ◯ | ◯ | ◯ |
| | | Advertising | | | |
| 0100b | SCAN_RSP | Primary | ◯ | | |
| | | Advertising | | | |
| 0101b | CONNECT_IND | Primary | ◯ | | |
| | | Advertising | | | |
| | AUX_CONNECT_REQ | Secondary | ◯ | ◯ | ◯ |
| | | Advertising | | | |
| 0110b | ADV_SCAN_IND | Primary | ◯ | | |
| | | Advertising | | | |

### Advertising PDU

The following advertising channel PDU types are called advertising PDUs and are used for specific events.
ADV_IND: a connectable non-directional advertisement event
ADV_DIREC_IND: a connectable directional advertisement event
ADV_NONCONN_IND: a non-connectable non-directional advertisement event
ADV_SCAN_IND: a non-directional advertisement event that may be scanned

The PDUs are transmitted by the link layer in the advertising state and are received by the link layer in the scanning state or initiating state.

### Scanning PDUs

The advertising channel PDU type below is called a scanning PDU and is used in the status described below.

SCAN_REQ: transmitted by the link layer in the scanning state and received by the link layer in the advertising state.

SCAN_RSP: transmitted by the link layer in the advertising state and received by the link layer in the scanning state.

### Initiating PDUs

The advertising channel PDU type below is called an initiating PDU.

CONNECT_REQ: transmitted by the link layer in the initiating state and received by the link layer in the advertising state.

### Data Channel PDU

The data channel PDU may have a 16-bit header and various sizes of payloads and include a message integrity check (MIC) field.

The procedure, the state, the packet format, and the like in the BLE technology, which are described above, may be applied in order to perform methods proposed by the present disclosure.

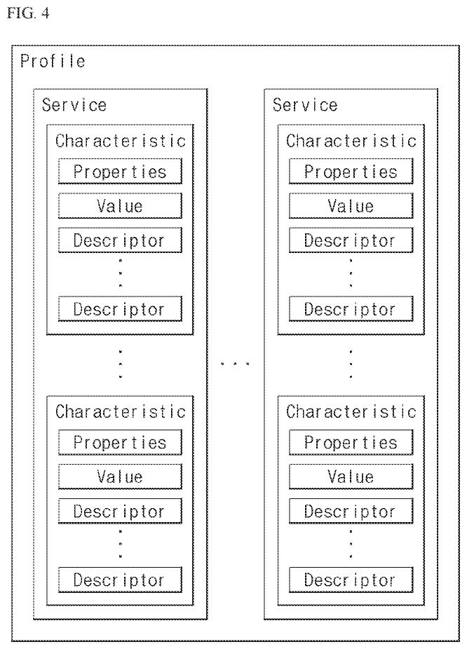

FIG. 4 illustrates an example of a structure of a generic attribute profile (GATT) of Bluetooth low energy.

Referring to FIG. 4, a structure for exchanging profile data of the Bluetooth low energy may be described.

Specifically, the generic attribute profile (GATT) is a definition of a method in which data is transmitted and received by using services and characteristics between the Bluetooth LE devices.

In general, a Peripheral device (e.g., a sensor device) serves as a GATT server and has a definition of services and characteristics.

A GATT client sends a data request to the GATT server in order to read or write the data and all transactions start at the GATT client and the response is received from the GATT server.

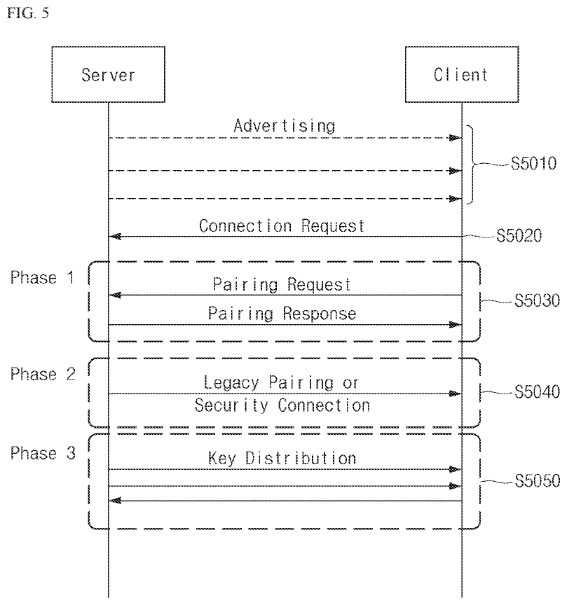

A GATT-based operation structure used in the Bluetooth LE may be based on THE profile, the service, and the characteristic, and may have a vertical structure illustrated in FIG. 5.

The profile may be constituted by one or more services and the service may be constituted by one or more characteristics or other services.

The service may serve to divide data into logical units and include one or more characteristics or other services. Each service has a 16-bit or 128-bit separator called a Universal Unique Identifier (UUID).

The characteristic is a lowest unit in the GATT-based operation structure. The characteristic includes only one datum and has a 16-bit or 128-bit UUID similar to the service.

The characteristic is defined as a value of various information and requires one attribute to contain each information. The characteristic may adopt various consecutive attributes.

The attribute is constituted by four components, which have the following meanings.
handle: Address of attribute
Type: Type of attribute
Value: Value of attribute
Permission: Access authority to attribute

FIG. 5 is a flowchart illustrating an example of a connection procedure method in Bluetooth low power energy technology to which the present disclosure may be applied.

A server transmits to a client an advertisement message through three advertising channels (S5010).

The server may be called an advertiser before connection and called as a master after the connection. As an example of the server, there may be a sensor (temperature sensor, etc.).

Further, the server may be called a scanner before the connection and called as a slave after the connection. As an example of the client, there may be a smartphone, etc.

As described above, in Bluetooth, communication is performed over a total of 40 channels through the 2.4 GHz band. Three channels among 40 channels as the advertising channels are used for exchanging sent and received for establishing the connection, which include various advertising packets.

The remaining 37 channels are used for data exchange after connection to the data channel.

The client may receive the advertisement message and thereafter, transmit the Scan Request message to the server in order to obtain additional data (e.g., a server device name, etc.).

In this case, the server transmits the Scan Response message including the additional data to the client in response to the Scan Request message.

Here, the Scan Request message and the Scan Response message are one type of advertising packet and the advertising packet may include only user data of 31 bytes or less.

Therefore, when there is data in which the size of the data is larger than 3 bytes, but overhead to transmit the data through the connection, the data is divided and sent twice by using the Scan Request message and the Scan Response message.

Next, the client transmits to the server a Connection Request message for establishing to a Bluetooth connection with the server (S5020).

Therefore, a Link Layer (LL) connection is established between the server and the client.

Thereafter, the server and the client perform a security establishment procedure.

The security establishment procedure may be interpreted as security simple pairing or may be performed including the same.

That is, the security establishment procedure may be performed through Phase 1 through Phase 3.

Specifically, a pairing procedure (Phase 1) is performed between the server and the client (S5030).

In the pairing procedure, the client transmits a Pairing Request message to the server and the server transmits a Pairing Response message to the client.

Through the pairing procedure, authentication requirements and input (I)/output (O) capabilities and Key Size information are sent and received between the devices. Through the information, which key generation method is to be used in Phase 2 is determined.

Next, as Phase 2, legacy pairing or secure connections are performed between the server and the client (S5040).

In Phase 2, A 128-bit temporary key and a 128-bit short term key (STK) for performing the legacy pairing are generated.
Temporary Key: Key made for creating the STK
Short Term Key (LTK): Key value used for making encrypted connection between devices

When the secure connection is performed in Phase 2, a 128-bit long term key (LTK) is generated.
Long Term Key (LTK): Key value used even in later connection in addition to encrypted connection between the devices

Next, as Phase 3, a Key Distribution procedure is performed between the server and the client (S5050).

Therefore, the secure connection may be established and the data may be transmitted and received by establishing the encrypted link.

### General Matters Related to Isochronous Channel

With respect to an audio signal, audio streaming data or audio data may be periodically generated at an idle event interval.

The audio data is generated periodically (or at a specific time interval) according to a feature thereof. Here, the specific time interval at which the audio data is periodically generated may be expressed as idle event interval. Each audio data is transmitted at each idle event interval. Further, each audio data may be transmitted through an entire interval or a partial interval of the idle event interval. When the audio streaming data which is generated periodically or regularly is transmitted by using a BLE mechanism, an advertising and scanning procedure, a communication procedure, and a disconnection procedure should be performed whenever the generated audio data is transmitted/received. However, the audio data is generally periodically generated, and latency guarantee for audio data transmission is required regardless of a data mount of the audio data.

However, when the advertising and scanning procedure, the communication procedure, and the disconnection procedure should be performed each time newly generated audio data is transmitted, there is a problem in that latency occurs in audio data transmission.

In audio data transmission through hearing aids (HA) or headset, a data generation amount is comparatively small, so when BLE technology is utilized, higher energy efficiency may be obtained than Bluetooth BR/EDR technology, but since a data channel process of the BLE technology should perform advertising, connection, etc., every data transmission as described above, the data transmission has large overhead, and in particular, latency guarantee absolutely required for the audio data transmission may not be guaranteed.

Further, since the data channel process of the BLE technology has a purpose of transmitting isolatedly generated data only as necessary, and inducing deep sleep of a BLE device in other time domains to increase energy efficiency, it may be difficult to apply the data channel process of the BLE technology to transmission of periodically generated audio data.

### Definition of Isochronous Channel and Mechanism Related Thereto

A new channel, i.e., an isochronous channel is defined in order to transmit the periodically generated data by using the BLE technology.

The isochronous channel is a channel used for transmitting the isochronous data between devices (e.g., conductor-member) using an isochronous stream.

The isochronous data refers to data transmitted at a specific time interval, i.e., periodically or regularly.

That is, the isochronous channel may represent a channel in which periodically generated data such as audio data or voice data is transmitted and received in the BLE technology. Further, the isochronous channel may represent a channel on which data generated based on a user input of a game user's controller device is transmitted and received in a gaming scenario. The isochronous channel can be used for transmitting and receiving data to and from a single member, a set of one or more coordinated members, or multiple members. Further, the isochronous channel corresponds to a flushing channel which can be used for transmitting and receiving key data in an isochronous stream such as an audio streaming or other time domains.

### Configuration of Various Embodiments of Present Disclosure

Device manufacturers design a device's report map (USB report descriptor) very carefully. ULL is mostly required for input reports.

Are two or more input reports required?

Should joystick movement and a button be separated for each gamepad? or combined as usual?

Should mouse movement and the button be separated for each mouse? or combined as usual?

Should a game key region and other regions be separated for each keyboard? or combined as usual?

When an output report is required for ULL, one ULL report path is sufficient since a report output direction is bidirectional.

According to a research of the present disclosure, using one ULL report path showed that 99% of devices were substantially normal.

On an HIDS device side, a ULL map of a hybrid mode characteristic is very simple and only map ULL report is displayed.

Device manufacturer will very carefully design device's report map (report descriptor in USB)

ULL is mostly necessary for Input report.

Do we need to more than one Input report?

Per gamepad, do we need to separate joystick move and button? or combine as usual?

Per Mouse, do we need to separate mouse move and button? or combine as usual?

Per Keyboard, do we need to separate game-key area and other area? or combine as usual?

If Output report is required to ULL, one ULL report-path is enough because it is bi-directional.

The present disclosure's study shows 99% devices are practically OK with one ULL report-path.

At HIDS Device side, ULL map in Hybrid mode Characteristic will be very simple, only maps ULL report.

TABLE 2

| Report ID (1 byte) | ULL HID Feature |
|---|---|
| 1 | Supported (input) |

TABLE 3

| Report ID (1 byte) | ULL HID Feature |
|---|---|
| 1 | Supported (input) |
| 2 | Supported (output) |

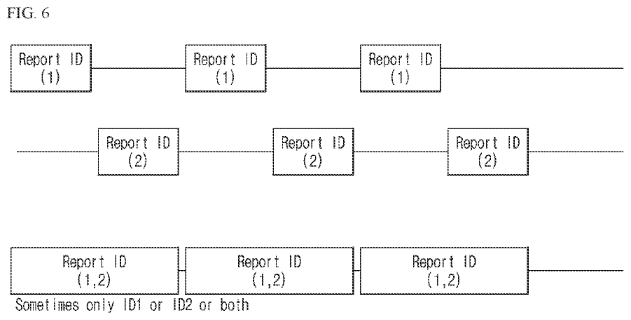

FIG. 6 illustrates an example of a configuration of a signal transmitted between a central device (host device or master device) and a peripheral device (slave device).

Nevertheless, when one or more ULL inputs per device are required (separate movement and button), what is a design method?

One CIS per ULL input report and one CIS that multiplexes all ULL input reports

One CIS per one ULL Input Report is architecturally simple, however, the device may have an available CIS channel limit due to a practical reason.

So just using one CIS multiplexing is practical.

However, in phase 1, only one ULL Report path is desired to be kept.

What other features are required for Hybrid Feature Characteristic?

ULL HID user experience will be improved if the Host can identify Device features at characteristic discovery stage.

Does the device have a mode change capability?

Device having special button or key can initiate the mode change.

This is optional feature. Mandatory mode change will be done at Host side.

Reliability compensation (ARQ, FEC) support?

Let Central know Device can use reliability compensation mechanism at the expense of latency.

At link layer, BN, NSE combination will handle.

At application layer. ARQ for conditional resending, FEC for redundant sending will handle.

### Packet Spacing Support?

The time required for one sub event will dramatically reduce. Much more space will be available.

It shall be exchanged at link layer. It's not application layer context.

### Reliability at Link Level

It is assumed that the reliability issue is mainly coming from network environment.

Where PER is critical index.

Link layer header ack/nack may handle that.

Application layer may rely on reliability through link layer's BN and NSE combination.

If BN=NSE, there is no retransmission, and sub event is flushed at the very end of the sub event.

If BN<NSE, retransmission happens until the sub event is flushed.

Nevertheless If we need more than one ULL Input per Device. (separate move and button) how to design?

One CIS per One ULL Input Report vs. One CIS multiplexing all ULL Input Reports

One CIS per One ULL Input Reports is architecturally simple, however, Device may have available CIS channels limit in practical reasons.

So just using one CIS multiplexing is practical.

But I want to keep only one ULL report-path at phasel.

What other features are necessary in Hybrid Feature Characteristic?

ULL HID user experience will be improved if the Host can identify Device features at characteristic discovery stage.

Mode change capability from Device?

Device having special button or key can initiate the mode change.

This is optional feature. Mandatory mode change will be done at Host side.

Reliability compensation (ARQ, FEC) support?

Let Central know Device can use reliability compensation mechanism at the expense of latency.

At link layer, BN, NSE combination will handle.

At application layer, ARQ for conditional resending, FEC for redundant sending will handle.

Packet spacing support?

The time required for one sub event will dramatically reduce. Much more space will be available.

It shall be exchanged at link layer. It's not application layer context.

### Reliability at Link Level

Assuming the reliance issue is mainly coming from network environment.

Where PER is critical index.

Link layer header ack/nack can handle that.

Application layer can rely on reliability through Link layer's BN. NSE combination.

If BN=NSE, no retransmission, Sub event is flushed at the very end of the sub event.

If BN<NSE, retransmission happens until the sub event is flushed.

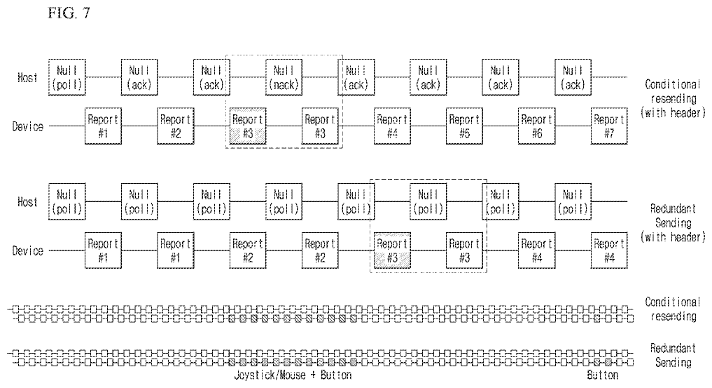

FIG. 7 illustrates an example of a configuration of a signal transmitted between a central device (host device or master device) and a peripheral device (slave device).

### Application-Level Stability

Application layer packet headers help increase stability while keeping latency as short as possible.

The joystick/mouse report rate is 1000 Hz with 1 ms intervals, providing very fast continuous input. Most games do not require rapid movement changes. The typical nominal tick rate is 60 Hz, 120 Hz, or 144 Hz.

However, sporadic button reports are transmitted rapidly. Therefore, 1000 Hz must be maintained to minimize latency.

Redundant transmission occurs when joystick/mouse and buttons are used together, resulting in slower button response.

Transmitting buttons only also enables redundant transmission.

### Reliability at Application Level (ARQ and FEC)

### ARQ

### Conditional Retransmission

Seq # starts from 0 and increases by 1. When an ack is received, Seq # is reset to 0 (flushed).

A 2-bit Seq # can handle 3 retransmissions (0, 1, 2, 3).

If three retransmissions fail, the report is flushed. Seq # is reset to 0.

When a flush occurs, a Report is sent at that time to maintain low latency, and Reports received during the retransmission period are dropped.

### Forward Error Correction (FEC)

### Redundant Transmission

BN and NSE at Link layer have same value.

ULL Profile does not rely on link layer Ack/Nack mechanism.

### Operation Mode Characteristic

Operation mode affects both Host Device and Peripheral Device together.

This characteristic has write without response and optionally notification.

Host Device can assume mode change is always successful if two conditions are met.

ISO channel enable/disable: Link parameters for ULL connection may be carefully selected.

If not, there may be a failure due to central and peripheral link parameters mismatch.

Application data redirection (ACL<->ISO pass through) at each side: Fail possibility is very low.

However, it may fail due to application process mishandling or busy.

Peripheral Device can send Input report immediately after receiving Operation mode change request without receiving notification.

Host Device drops the incoming reports at first and receive the reports when state is successfully changed. It can be OK if the mode change is always successful and assuming jo report is valid only short period of time.

Alternatively, the Host Device needs to be synchronous in receiving the Input report from Peripheral Device.

After ISO Channel is enabled and application data redirection is done, the peripheral device starts transmission. No report is dropped.

### Link Parameters

BN=NSE (BN=0 . . . 15, NSE=1 . . . 31), FT=1(FT=1 . . . 255)
ISO_Interval: X1.25 ms, min=5 ms, max=4 Sec.
5, 6.25, 7.5, 8.75, 10, 11.25, 12.5, 13.75, 15, 16.25, 17.5, 18.75, 20

### Reliability at Application Level

Application layer packet header can help increase reliability while keep latency as small as possible.

At 1 ms Interval, Joystick/Mouse report rate is 1000 hz, which is very fast continuous input. Most game does not require that fast movement change. Nominal tick rate is 60 hz, 120 hz or 144 hz.

But sporadic button report shall be quickly sent. So It shall be kept 1000 hz to minimize latency.

Redundant sending, if Joystick/Mouse+Buttons are together, Button response is slowed.

If Button is only sent, Redundant sending will be OK.

### Reliability at Application Level (ARQ and FEC)

### ARQ

### Conditional Resending

Seq # starts from 0, increase by 1. When ack is received, Seq # resets to 0. (flushed)

bit Seq # can handle 3 times retransmission. (0, 1, 2, 3)

If 3 times retransmission does not succeed, the Report is flushed, the Seq # resets to 0,

When flush happens, Send the report at that time to keep latency small, drop reports received at retransmission period.

### Forward Error Correction (FEC)

### Redundant Sending

BN, NSE at Link layer has same value.

ULL Profile does not rely on Link layer Ack/Nack mechanism.

### Operation Mode Characteristic

Operation mode affects both Host Device and Peripheral Device together.

This characteristic has write without response and optionally notification.

Host Device can assume mode change is always successful if two conditions are met.

ISO channel enable/disable: We can carefully select link parameters for ULL connection.

If not, may fail due to central and peripheral link parameters mismatch.

Application data redirection (ACL<->ISO pass through) at each side: fail possibility is very low.

However, it may fail due to application process mishandling or busy.

Peripheral Device can send Input report immediately after receiving Operation mode change request without receiving notification.

Host Device drops the incoming reports at first and receive the reports when state is successfully changed. It can be OK if the mode change is always successful and assuming report is valid only short period of time.

Alternatively, the Host Device needs to be synchronous in receiving the Input report from Peripheral Device.

After ISO Channel enabled and application data redirection done, the peripheral Device starts sending. No reports are dropped.

### Link Parameters

BN=NSE (BN=0.15, NSE=1 . . . 31), FT=1(FT=1 . . . 255)
ISO_Interval: X1.25 ms, min=5 ms, max=4Sec.
5, 6.25, 7.5, 8.75, 10, 11.25, 12.5, 13.75, 15, 16.25, 17.5, 18.75, 20

TABLE 4

| Sub_Interval | ISO_Interval (BN = NSE) |
|---|---|
| 1 ms | 5 ms(5), 10 ms(10), 15 ms(15), 20 ms |
| 2 ms | 10 ms(5), 20 ms(10) |
| 3 ms | 15 ms(5) |
| 4 ms | 20 ms(5) |
| 5 ms | 5 ms(1), 10 ms(2), 15 ms(3), 20 ms(4) |

TABLE 5

| | |
|---|---|
| Sub_Interval | ISO_Interval (BN = NSE) |

| | | |
|---|---|---|
| 1.25 | ms | 5 ms(4), 6.25 ms(5), 7.5 ms(6), 8.75 ms(7), |
| | | 10 ms(8), 11.25 ms, 12.5 ms, . . . , 20 ms |
| 2.5 | ms | 5 ms(2), 7.5 ms(3), 10 ms(4), 12.5 ms(5), |
| | | 15 ms(6), 17.5 ms(7), 20 ms(8) |
| 3.75 | ms | 7.5 ms(2), 11.25 ms(3), 15 ms(4), 18.75 ms(5) |
| 5 | ms | 5 ms(1), 10 ms(2), 15 ms(3), 20 ms(4) |

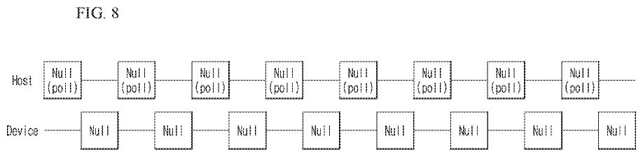

FIG. 8 illustrates an example of a configuration of a signal transmitted between a central device (host device or master device) and a peripheral device (slave device).

### (Back-Up) Normal Packet Monitoring at ULL ISO Path

During game, Continuous report transfer will happen only short period when Joystick/Mouse moves. Most of the time, the Air interface is filled with Null pairs.

### (Back-Up) Normal Packet Monitoring at ULL ISO Path

During game, Continuous report transfer will happen only short period when Joystick/Mouse moves. Most of the time, the Air interface is filled with Null pairs.

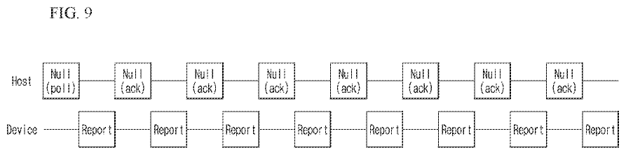

FIG. 9 illustrates an example of a configuration of a signal transmitted between a central device (host device or master device) and a peripheral device (slave device).

Some device implementation sends current status even though the input does not change.

Some device implementation sends current status even though the input does not change.

### Summary (the Present Disclosure)

1> ULL support feature (1 bit) in Hybrid feature characteristic can be omitted. The very existence of Hybrid feature characteristic itself is ULL support feature.

But it is left for now, if additional features are added to require more bits. If no other feature is necessary in the end, it can be omitted.

2> ISO pass through data may have a header in ARQ mode for responsibility at application layer. To minimize overhead and considering the short valid period of ULL traffic,

Max. 1 byte header (sequence number, ack number) will be OK. In the case of FEC, no header will be OK.

Consensus so far is we can add header. But it needs to balance between implementation difficulty and the benefit from it.

If the reliance issue is mainly coming from network environment (PER), Link layer ack/nack can handle somehow.

Application layer also helps improving reliability.

3> Operation mode characteristic may have link connection parameters such as ISO Interval, Sub Interval, BN, NSE, FT so as to make link connection deterministic.

Or the characteristic has only has a certain application layer context mapping value which represents those link parameters.

Or the characteristic will use SDU_Interval for controller to make link parameters to satisfy the SDU_Interval.

Consensus so far is using the SDU_Interval+a few mapping parameters with which carefully chosen link parameters relate.

4> Operation mode characteristic may requires Notify as an confirmation of state change. It may increase the complexity but also increase peer communication's stability too.

### About the Characteristic Called Hybrid Feature: (Frank)

Hybrid feature could be separated in 2:
Hybrid Mode Supported Intervals (Mandatory: List of supported intervals, Read)
Hybrid Mode Report ID Map (Optional: One bit for each Report ID, Read: What is supported by the HID device, Write: Ability for HID Host to clear bits (certain report to go over ACL even if device supports ISO)

### Control Point:

The conventional control point can be reused
Add new commands to control enter/exit hyper mode
Add a conditional “Notify Property” (mandatory for devices that supports output reports over ISO in Hybrid mode OR have UX to request hyper mode, otherwise excluded)
Add “response” for the case(s) where the Host need to know that a command is completed
Add “requests” (notify) for devices that want to request hyper mode/request terminate hyper mode

Some careless Device manufacturer may set all report IDs support ULL even though it's not necessary (Mouse Input, Joystick Input, Battery level Input). In this case, Host need to statically disable the misconfigured report ID by its own discretion. We need also to consider once switched to Hybrid mode, ULL ISO pass through connection is there. Central will poll with very short sub interval nevertheless misconfigured report ID is disabled.

### The Present Disclosure's Response

In various embodiments of the present disclosure, we shared common design philosophy that we will not change existing characteristic for stable backward compatibility.

With that in mind, it is a bit reluctant to reuse existing characteristic by adding new property/protocol/procedure equivalently extend old one.

It is a bit inclined to clearly separate v1.0 characteristic and v1.1 characteristic to implement easier and guarantee backward compatible as it is.

As you may know, application architecture design may have various facets to achieve same thing (goal) at initial stage.

So the first step agreement would be very critical for the next entire steps.
The design
HIDS additions
Hybrid Feature Characteristic (Read)
ULL HID features
available Intervals
map Report ID (in Report descriptor of USB) with ULL HID feature
Operation mode Characteristic (Write without response, Notify)
change between operation mode—Hybrid enable/disable Write w/o response. (from Host)
reflect current operation status—operation mode, interval, report ID (Notify)
also used from Device—Hybrid enable/disable (Notify) initiating ULL CP operation at Host.

### Hybrid Feature Characteristic

Expose the device's capability of supporting ULL HID Feature
Hybrid mode features
Report Interval supporting sets
Map Report IDs with Hybrid mode

### Summary (the Present Disclosure)

1> ULL support feature (1 bit) in Hybrid feature characteristic can be omitted. The very existence of Hybrid feature characteristic itself is ULL support feature.

But it is left for now, if additional features added to require more bits. It no other feature is necessary in the end, it can be omitted.

2> ISO pass through data may have a header in ARQ mode for responsibility at application layer. To minimize overhead and considering the short valid period of ULL traffic.

Max. 1 byte header (sequence number, ack number) will be OK. In the case of FEC, no header will be OK.

Consensus so far is we can add header. But it needs to balance between implementation difficulty and the benefit from it.

If the reliance issue is mainly coming from network environment (PER), Link layer ack/nack can handle somehow.

Application layer also helps improving reliability.

3> Operation mode characteristic may have link connection parameters such as ISO Interval, Sub Interval, BN, NSE, FT so as to make link connection deterministic.

Or the characteristic has only has a certain application layer context mapping value which represents those link parameters.

Or the characteristic will use SDU_Interval for controller to make link parameters to satisfy the SDU_Interval.

Consensus so far is using the SDU_Interval+a few mapping parameters with which carefully chosen link parameters relate.

4> Operation mode characteristic may requires Notify as an confirmation of state change. It may increase the complexity but also increase peer communication's stability too.
About the characteristic called Hybrid feature: (Frank)
Hybrid feature could be separated in 2:
Hybrid Mode Supported Intervals (Mandatory: List of supported intervals, Read)
Hybrid Mode Report ID Map (Optional: One bit for each Report ID, Read: What is supported by the HID device, Write: Ability for HID Host to clear bits (certain report to go over ACL even if device supports ISO)

### Control Point:

The existing control point can be reused
Add new commands to control enter/exit hyper mode
Add a conditional “Notify Property” (mandatory for devices that supports output reports over ISO in Hybrid mode OR have UX to request hyper mode, otherwise excluded)
Add “response” for the case(s) where the Host need to know that a command is completed
Add “requests” (notify) for devices that want to request hyper mode/request terminate hyper mode
Some careless Device manufacturer may set all report IDs support ULL even though it's not necessary (Mouse Input, Joystick Input, Battery level Input). In this case, Host need to statically disable the misconfigured report ID by its own discretion. We need also to consider once switched to Hybrid mode, ULL ISO pass through connection is there. Central will poll with very short sub interval nevertheless misconfigured report ID is disabled.

### The Present Disclosure's Response

In various embodiments of the present disclosure, we shared common design philosophy that we will not change existing characteristic for stable backward compatibility.

With that in mind, it is a bit reluctant to reuse existing characteristic by adding new property/protocol/procedure equivalently extend old one.

It is a bit inclined to clearly separate v1.0 characteristic and v1.1 characteristic to implement easier and guarantee backward compatible as it is.

As you may know, application architecture design may have various facets to achieve same thing (goal) at initial stage.

So the first step agreement would be very critical for the next entire steps.
The design
HIDS additions
Hybrid Feature Characteristic (Read)
ULL HID features
available Intervals
map Report ID (in Report descriptor of USB) with ULL HID feature
Operation mode Characteristic (Write without response, Notify)
change between operation mode—Hybrid enable/disable Write w/o response. (from Host)
reflect current operation status—operation mode, interval, report ID (Notify)
also used from Device—Hybrid enable/disable (Notify) initiating ULL CP operation at Host.

### Hybrid Feature Characteristic

Expose the device's capability of supporting ULL HID Feature
Hybrid mode features
Report Interval supporting sets
Map Report IDs with Hybrid mode

TABLE 6
Hybrid Feature Characteristic

Hybrid features
Report Interval = 1, 2, 3, 4, 5 ms
Report ID = 1, 2

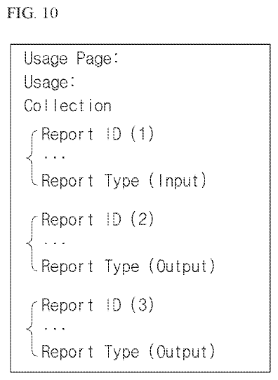

FIG. 10 illustrates an example of a configuration of a signal transmitted between a central device (host device or master device) and a peripheral device (slave device).

### Report ID Attributes

FIG. 10 illustrates an example of a Report Descriptor (USB).

Note> Report type: Mostly Input report will be used for ULL, sometimes Output report. Feature report will not be used.

If this Report supports ULL HID feature,

Map this ID with ULL HID feature in ULL map Characteristic.

### <Meaning>

This Report will be sent through GATT in Default mode.

It will be sent through ISO Transport in Hybrid mode.

Note> Report type: Mostly Input report will be used for ULL, sometimes Output report. Feature report will not be used.

If this Report supports ULL HID feature,

Map this ID with ULL HID feature in ULL map Characteristic

### <Meaning>

This Report will be sent through GATT in Default mode.

It will be sent through ISO Transport in Hybrid mode.

Table 7 shows a ULL map in Hybrid Feature Characteristic (Bluetooth).

TABLE 7

| Report ID (1 byte) | ULL HID Feature |
|---|---|
| 1 | Supported (Input) |
| 2 | Supported (Output) |
| 3 | Not Supported |

Note> If Only one Report is available, Report can be used without Report ID. For this case, only one row in the map table with blank Report ID.

Note> If Only one Report is available, Report can be used without Report ID. For this case, only one row in the map table with blank Report ID.

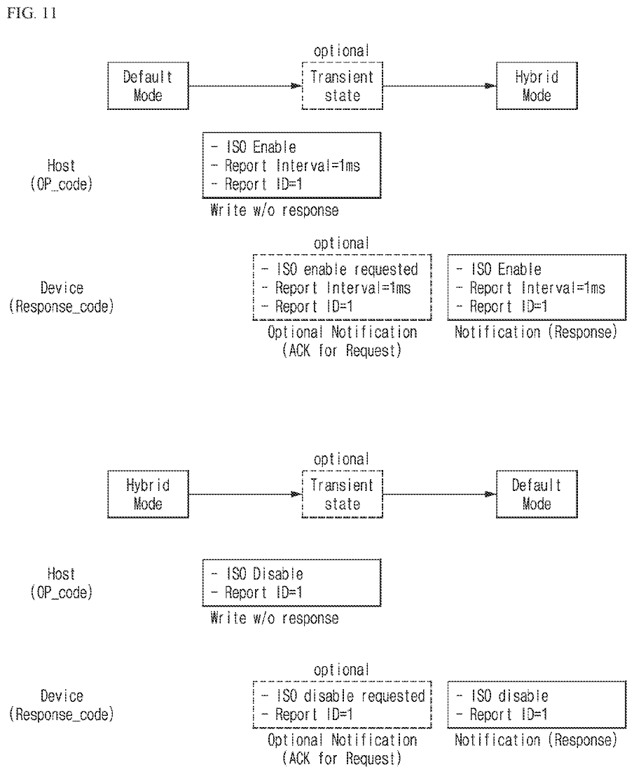

FIG. 11 illustrates an example of a mode change configuration of a central device (host device or master device) and a peripheral device (slave device) according to various embodiments of the present disclosure.

### Operation Mode Characteristic (Host to Device Example)

### Operation Mode Characteristic (Format)

Table 8 shows a request.

TABLE 8

| OP_Code | Parameter |
|---|---|
| Enable | Report Interval, Report ID |
| Disable | Report ID |

We can add not only Report Interval, but also very specific link timing parameters such as Sub_Interval, as well as ISO_Interval, BN, NSE, FT.

Or we can simply assume SDU_Interval (in LE Set CIG Parameters HCI command at Host) is same as Report Interval.

WG members agreed using SDU_Interval which is related with carefully chosen link parameters.

We can add not only Report Interval, but also very specific link timing parameters such as Sub_Interval, as well as ISO_Interval, BN, NSE, FT.

Or we can simply assume SDU_Interval (in LE Set CIG Parameters HCI command at Host) is same as Report Interval.

WG members agreed using SDU_Interval which is related with carefully chosen link parameters.

Table 9 shows a response.

TABLE 9

| | | |
|---|---|---|
| OP_Code | Response_Code | Parameter |

| | |
|---|---|
| Success | Related parameters |
| Error1 | Error1 reasons |
| Error2 | Error2 reasons |

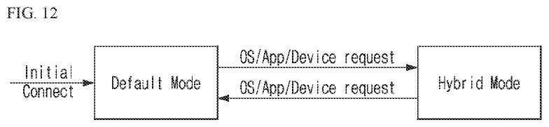

FIG. 12 illustrates an example of a mode change configuration of a central device (host device or master device) and a peripheral device (slave device) according to various embodiments of the present disclosure.
The design
HOGP additions
State diagram between Default and Hybrid mode
GATT-based behaviors/procedures for enable/disable Hybrid mode
Both Host and Device are in the same operation mode
OS/App requests means the Host initiates operation mode change.
Device request means the Device initiates operation mode change.

### Operation Mode Switch

Initial boot-up mode is always “Default” mode (Reliable GATT)
Both Host's and Device's reports are sent through conventional HOGP/HIDS GATT.
Changing from “Default” mode (Reliable GATT) to “Hybrid” mode (ULL CIS)
After ULL game starts, Both Host and Device can change to “Hybrid” mode
Host: “Hybrid” mode setup by Game UI or OS UI.
Device: By pressing button/key, “Hybrid” mode Notification initiates Host's “Hybrid” mode setup.
Returning from “Hybrid” mode to “Default” mode

During ULL game, Both Host and Device can change to “Default” mode.

When exiting ULL game or context switch (e.g., Alt+Tab in windows), Host should change to “Default” mode.

However, the spec cannot handle abnormal exits (OS crash, App crash, etc . . . ).
The design
HOGP additions
State diagram between Default and Hybrid mode
GATT-based behaviors/procedures for enable/disable Hybrid mode
Both Host and Device are in the same operation mode
OS/App requests means the Host initiates operation mode change.
Device request means the Device initiates operation mode change.

### Operation Mode Switch

Initial boot-up mode is always “Default” mode (Reliable GATT)
Both Host's and Device's reports are sent through conventional HOGP/HIDS GATT.
Changing from “Default” mode (Reliable GATT) to “Hybrid” mode (ULL CIS)
After ULL game starts, Both Host and Device can change to “Hybrid” mode
Host: “Hybrid” mode setup by Game UI or OS UI.
Device: By pressing button/key, “Hybrid” mode Notification initiates Host's “Hybrid” mode setup.
Returning from “Hybrid” mode to “Default” mode
During ULL game, Both Host and Device can change to “Default” mode.

When exiting ULL game or context switch (e.g., Alt+Tab in windows), Host should change to “Default” mode.

However, the spec cannot handle abnormal exits (OS crash, App crash, etc . . . ).

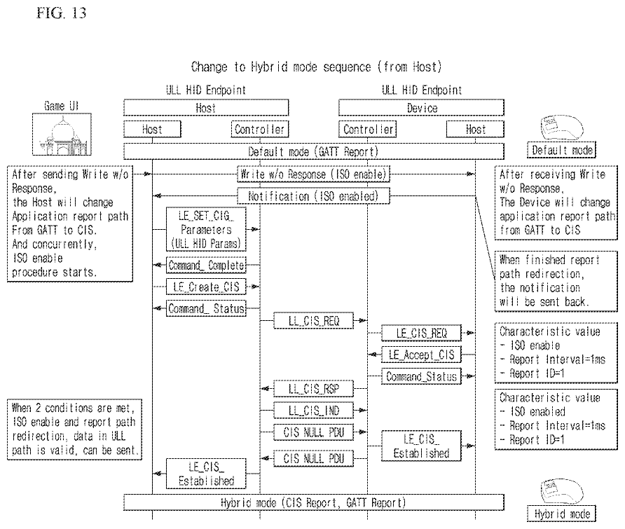

FIG. 13 illustrates an example of a change sequence to a hybrid mode in a short-range wireless communication system according to various embodiments of the present disclosure.

After sending Write w/o Response, the Host will change Application report path from GATT to CIS. And concurrently, ISO enable procedure starts.

After receiving Write w/o Response, the peripheral Device will change application report path from GATT to CIS. When finished report path redirection, the notification will be sent back.

When 2 conditions are met, ISO enable and report path redirection, data in ULL path is valid, can be sent.

After sending Write w/o Response, the Host will change Application report path from GATT to CIS. And concurrently, ISO enable procedure starts.

After receiving Write w/o Response, the peripheral Device will change application report path from GATT to CIS. When finished report path redirection, the notification will be sent back.

When 2 conditions are met, ISO enable and report path redirection, data in ULL path is valid, can be sent.

Table 10 shows a Write w/o Response.

TABLE 10
Characteristic value

ISO enable
Report Interval = 1 ms
Report ID = 1

Table 11 shows the notification.

TABLE 11
Characteristic value

ISO enabled
Report Interval = 1 ms
Report ID = 1

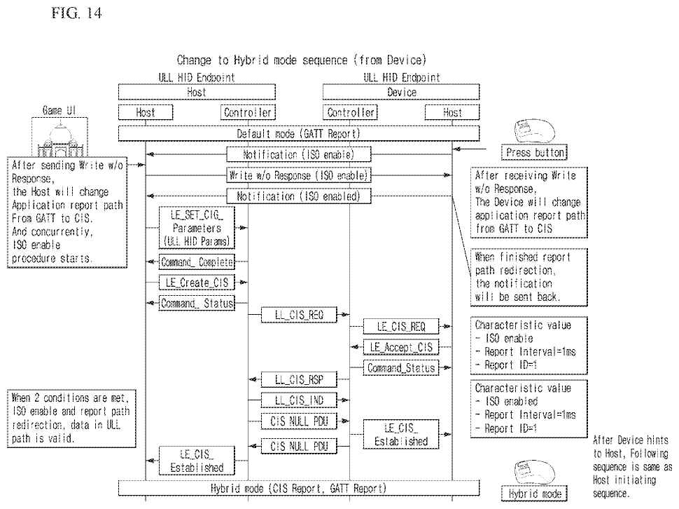

FIG. 14 illustrates an example of a change sequence to a hybrid mode in a short-range wireless communication system according to various embodiments of the present disclosure.

After sending Write w/o Response, the Host will change Application report path from GATT to CIS. And concurrently. ISO enable procedure starts.

After receiving Write w/o Response, the peripheral Device will change application report path from GATT to CIS.

When finished report path redirection, the notification will be sent back.

When 2 conditions are met, ISO enable and report path redirection, data in ULL path is valid.

After the peripheral Device hints to the Host, Following sequence is same as the Host initiating sequence.

After sending Write w/o Response, the Host will change Application report path from GATT to CIS. And concurrently, ISO enable procedure starts.

After receiving Write w/o Response, the peripheral Device will change application report path from GATT to CIS.

When finished report path redirection, the notification will be sent back.

When 2 conditions are met, ISO enable and report path redirection, data in ULL path is valid.

After the peripheral Device hints to the Host, Following sequence is same as the Host initiating sequence.

Table 12 shows a Write w/o Response.

TABLE 12
Characteristic value

ISO enable
Report Interval = 1 ms
Report ID = 1

Table 13 shows the notification.

TABLE 13
Characteristic value

ISO enabled
Report Interval = 1 ms
Report ID = 1

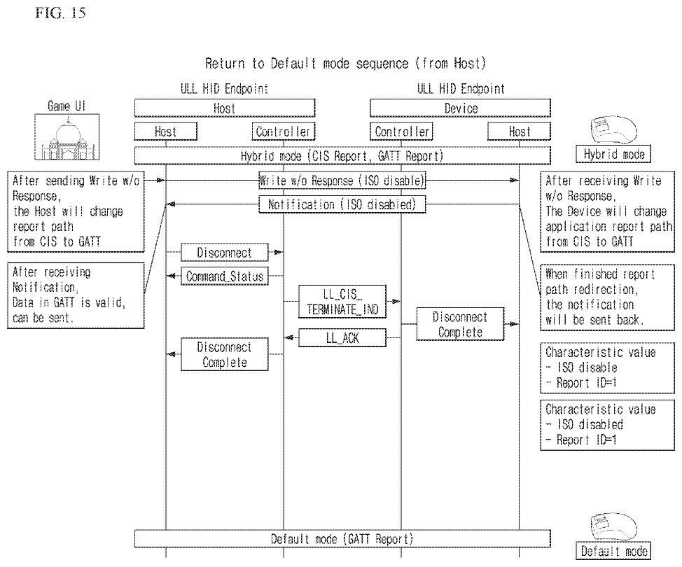

FIG. 15 illustrates an example of a change sequence to a default mode in the short-range wireless communication system according to various embodiments of the present disclosure.

After sending Write w/o Response, the Host will change report path from CIS to GATT.

After receiving Notification, Data in GATT is valid, can be sent.

After receiving Write w/o Response, the peripheral Device will change application report path from CIS to GATT.

When finished Report path Redirection, the notification will be sent back.

After sending Write w/o Response, the Host will change report path from CIS to GATT.

After receiving Notification, Data in GATT is valid, can be sent.

After receiving Write w/o Response, the peripheral Device will change application report path from CIS to GATT.

When finished Report path Redirection, the notification will be sent back.

Table 14 shows a Write w/o Response.

TABLE 14
Characteristic value

ISO disable
Report ID = 1

Table 15 shows the notification.

TABLE 15
Characteristic value

ISO disabled
Report ID = 1

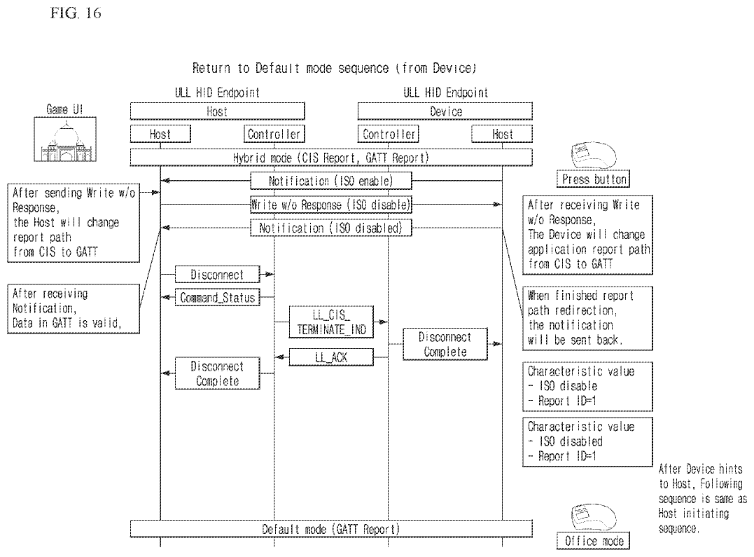

FIG. 16 illustrates an example of a change sequence to a default mode in the short-range wireless communication system according to various embodiments of the present disclosure.

After sending Write w/o Response, the Host will change report path from CIS to GATT.

After receiving Notification, Data in GATT is valid.

After receiving Write w/o Response, the peripheral Device will change application report path from CIS to GATT.

When finished Report path Redirection, the notification will be sent back.

After the peripheral Device hints to Host following sequence is same as Host initiating sequence.

After sending Write w/o Response, the Host will change report path from CIS to GATT.

After receiving Notification. Data in GATT is valid.

After receiving Write w/o Response, the peripheral Device will change application report path from CIS to GATT.

When finished Report path Redirection, the notification will be sent back.

After the peripheral Device hints to Host, following sequence is same as Host initiating sequence.

Table 16 shows a Write w/o Response.

TABLE 16
Characteristic value

ISO disable
Report ID = 1

Table 17 shows the notification.

TABLE 17
Characteristic value

ISO disabled
Report ID = 1

### [Description Related to Host Device Claim]

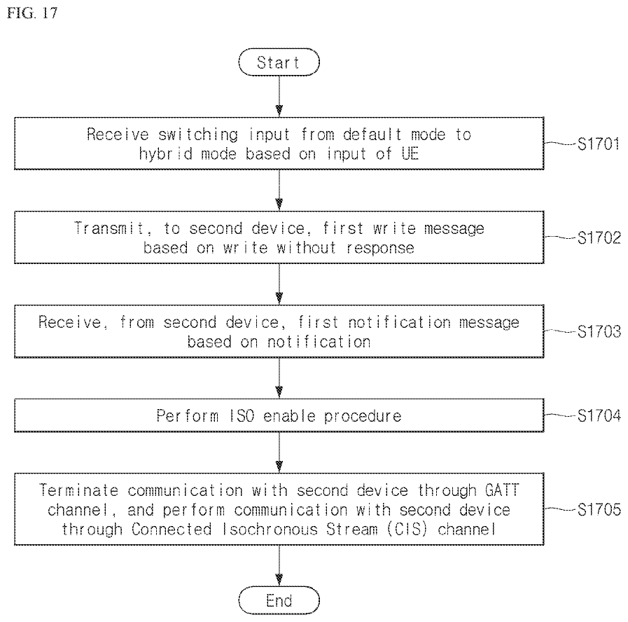

Hereinafter, the above-described embodiments will be described in detail with reference to FIG. 17 in terms of the operation of a UE. Methods to be described below are just distinguished for convenience and unless the methods mutually exclusive, it is needless to say that some components of any one method may be substituted with some components of another method or may be applied in combination with each other.

FIG. 17 illustrates an example of an operation process of a wireless device in the short-range wireless communication system according to various embodiments of the present disclosure.

According to various embodiments of the present disclosure, a method performed by a wireless device (i.e., a first device) in a short-range wireless communication system is provided.

The first device includes: a first processor corresponding to a host stack; a second processor corresponding to a controller stack; a memory; an input device corresponding to a user interface (UI); an output device corresponding to the UI; and a transceiver. The host stack and the controller stack are connected by a Host Controller Interface (HCI).

In step S1701, a first device receives a switching input from a default mode to a hybrid mode based on an input of the UI. The first device corresponding to a host and a second device corresponding to a peripheral device are connected through a Generic Attribute Profile (GA TT) channel in the default mode.

In step S1702, the first device transmits a first write message based on write without response to the second device. The first write message is related to an Isochronous Channel (ISO) enable instruction.

In step S1703, the first device receives a first notification message based on a notification from the second device. The first notification message is related to an ISO enabled indication.

In step S1704, the first device performs an ISO enable procedure.

In step S1705, the first device terminates communication with the second device through the GATT channel, and performs the communication with the second device through a Connected Isochronous Stream (CIS) channel.

According to various embodiments of the present disclosure, communication between the first device and the second device may be performed only through the GATT channel in the default mode. The communication between the first device and the second device may be performed through the CIS channel in the hybrid mode.

According to various embodiments of the present disclosure, the embodiment of FIG. 17 may further include receiving a second notification message based on a notification from the second device based on a specific switch input of the second device. The second notification message may be related to the ISO enable instruction. The first write message may be transmitted in response to the second notification message.

According to various embodiments of the present disclosure, the embodiment of FIG. 17 may further include: receiving a switching input from the hybrid mode to the default mode based on the input of the UI: transmitting a second write message based on write without response to the second device, wherein the second write message is related to an Isochronous Channel (ISO) disable instruction: receiving a third notification message based on a notification from the second device, wherein the third notification message is related to an ISO disabled indication; and terminating communication with the second device through the CIS channel and performing the communication with the second device through the GATT channel.

According to various embodiments of the present disclosure, the embodiment of FIG. 17 may further include receiving a fourth notification message based on a notification from the second device based on a specific switch input of the second device, wherein the fourth notification message is related to the ISO disable instruction. The second write message may be transmitted in response to the fourth notification message.

According to various embodiments of the present disclosure, in the hybrid mode, report information may be received from the second device to the first device through the CIS channel, and a report interval of the report information may be 1 ms.

According to various embodiments of the present disclosure, when switching from the hybrid mode to the default mode, report information may be received from the second device to the first device through the GATT channel, and the report interval of the report information may be 1 ms or more.

According to various embodiments of the present disclosure, a wireless device is provided in a short-range wireless communication system. The wireless device includes: a first processor corresponding to a host stack; a second processor corresponding to a controller stack; a memory, an input device corresponding to a user interface (UI); an output device corresponding to the UI; and a transceiver. The host stack and the controller stack are connected by a Host Controller Interface (HCI). The memory may be configured to store instructions for performing the operation method of the first device according to FIG. 17 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the first device according to FIG. 17 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the first device according to FIG. 17.

### [Description Related to Peripheral Device Claim]

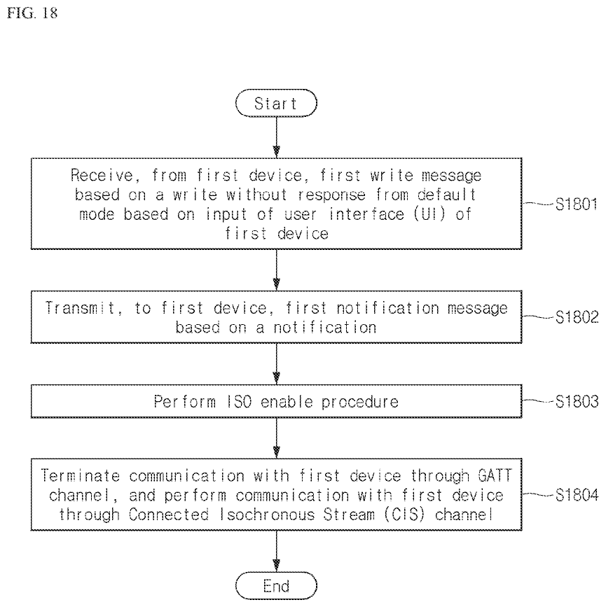

Hereinafter, the above-described embodiments will be described in detail with reference to FIG. 18 in terms of the operation of a UE. Methods to be described below are just distinguished for convenience and unless the methods mutually exclusive, it is needless to say that some components of any one method may be substituted with some components of another method or may be applied in combination with each other.

FIG. 18 illustrates an example of an operation process of a wireless device in the short-range wireless communication system according to various embodiments of the present disclosure.

According to various embodiments of the present disclosure, a method performed by a wireless device (i.e., a second device) in a short-range wireless communication system is provided.

The second device includes: a first processor corresponding to a host stack; a second processor corresponding to a controller stack; a memory: a specific switch for an input; and a transceiver. The host stack and the controller stack are connected by a Host Controller Interface (HCI).

In step S1801, a second device receives, from a first device, a first write message based on write without response from a default mode based on an input of a user interface (UI) of the first device. The first device corresponding to a host and the second device corresponding to a peripheral device are connected through a Generic Attribute Profile (GAT) channel. The first write message is related to an Isochronous Channel (ISO) enable instruction.

In step S1802, the second device transmits a first notification message based on a notification to the first device. The first notification message is related to an ISO enabled indication.

In step S1803, the second device performs an ISO enable procedure.

In step S1804, the second device terminates communication with the first device through the GATT channel, and performs the communication with the first device through a Connected Isochronous Stream (CIS) channel.

According to various embodiments of the present disclosure, communication between the first device and the second device may be performed only through the GATT channel in the default mode. The communication between the first device and the second device may be performed through the GATT channel and the CIS channel in the hybrid mode.

According to various embodiments of the present disclosure, the embodiment of FIG. 18 may further include transmitting a second notification message based on a notification to the first device based on a specific switch input of the second device. The second notification message may be related to the ISO enable instruction. The first write message may be received in response to the second notification message.

According to various embodiments of the present disclosure, the embodiment of FIG. 18 may further include: receiving a second write message based on write without response based on an input of the UE of the first device from the first device, wherein the second write message is related to an Isochronous Channel (ISO) disable instruction; transmitting a third notification message based on a notification to the first device, wherein the third notification message is related to an ISO disabled indication; and terminating communication with the first device through the CIS channel and performing the communication with the first device through the GATT channel.

According to various embodiments of the present disclosure, the embodiment of FIG. 18 may further include transmitting a fourth notification message based on a notification to the first device based on a specific switch input of the second device, wherein the fourth notification message is related to the ISO disable instruction. The second write message may be received in response to the fourth notification message.

According to various embodiments of the present disclosure, in the hybrid mode, report information may be transmitted from the second device to the first device through the CIS channel, and the report interval of the report information may be 1 ms.

According to various embodiments of the present disclosure, when switching from the hybrid mode to the default mode, report information may be transmitted from the second device to the first device through the GATT channel, and a report interval of the report information may be 1 ms or more.

According to various embodiments of the present disclosure, a wireless device is provided in a short-range wireless communication system. The wireless device includes: a first processor corresponding to a host stack; a second processor corresponding to a controller stack; a memory: a specific switch for an input; and a transceiver. The host stack and the controller stack are connected by a Host Controller Interface (HCI). The memory may be configured to store instructions for performing the operation method of the second device according to FIG. 18 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the second device according to FIG. 18 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the second device according to FIG. 18.

Claims set forth in various embodiments of the present disclosure may be combined in various schemes. For example, technical features of method claims of various embodiments of the present disclosure may be combined and implemented as a device, and technical features of device claims of various embodiments of the present disclosure may be combined and implemented as a method. Further, the technical features of the method claims and the technical features of the device claims of various embodiments of the present disclosure may be combined and implemented as the device, and the technical features of the method claims and the technical features of the device claims of various embodiments of the present disclosure may be combined and implemented as the method.

1. An operation method of a first device in a short-range wireless communication system, wherein the first device includes: a first processor corresponding to a host stack; a second processor corresponding to a controller stack; a memory; an input device corresponding to a user interface (UI); an output device corresponding to the UI; and a transceiver, and the host stack and the controller stack being connected via a Host Controller Interface (HCI), the method comprising:
receiving a switching input from a default mode to a hybrid mode based on an input of the UE, wherein the first device corresponding to a host and a second device corresponding to a peripheral device are connected through a Generic Attribute Profile (GATT) channel in the default mode;
transmitting, to the second device, a first write message based on a write without response, wherein the first write message is related to an Isochronous Channel (ISO) enable instruction;
receiving, from the second device, a first notification message based on a notification, wherein the first notification message is related to an ISO enabled indication;
performing an ISO enable procedure; and
terminating communication with the second device through the GATT channel, and performing communication with the second device through a Connected Isochronous Stream (CIS) channel.

2. The method of claim 1, wherein communication between the first device and the second device is performed only through the GATT channel in the default mode, and
wherein the communication between the first device and the second device is performed through the CIS channel in the hybrid mode.

3. The method of claim 1, further comprising:
receiving, from the second device, a second notification message based on the notification based on a specific switch input of the second device, wherein the second notification message is related to the ISO enable instruction,
wherein the first write message is transmitted in response to the second notification message.

4. The method of claim 1, further comprising:
receiving a switching input from the hybrid mode to the default mode based on the input of the UI;
transmitting, to the second device, a second write message based on the write without response, wherein the second write message is related to an Isochronous Channel (ISO) disable instruction;
receiving, from the second device, a third notification message based on the notification, wherein the third notification message is related to an ISO disabled indication; and
terminating communication with the second device through the CIS channel, and performing the communication with the second device through the GATT channel.

5. The method of claim 4, further comprising:
receiving, from the second device, a fourth notification message based on the notification based on the specific switch input of the second device, wherein the fourth notification message is related to the ISO disable instruction,
wherein the second write message is transmitted in response to the fourth notification message.

6. The method of claim 1, wherein report information is received from the second device to the first device through the CIS channel in the hybrid mode, and
wherein a report interval of the report information is 1 ms.

7. The method of claim 4, wherein when the switching from the hybrid mode to the default mode is performed,
the report information is received from the second device to the first device through the GATT channel, and
wherein the report interval of the report information is 1 ms or more.

8. An operation method of a second device in a short-range wireless communication system, wherein the second device includes: a first processor corresponding to a host stack; a second processor corresponding to a controller stack; a memory; a specific switch for an input; and a transceiver, and the host stack and the controller are connected via a Host Controller Interface (HCI), the method comprising:
receiving, from a first device, a first write message based on a write without response from a default mode based on an input of a user interface (UI) of the first device, wherein the first device corresponding to a host and the second device corresponding to a peripheral device are connected through a Generic Attribute Profile (GATT) channel, and wherein the first write message is related to an Isochronous Channel (ISO) enable instruction;
transmitting, to the first device, a first notification message based on a notification, wherein the first notification message is related to an ISO enabled indication;
performing an ISO enable procedure; and
terminating communication with the first device through the GATT channel, and performing the communication with the first device through a Connected Isochronous Stream (CIS) channel.

9. The method of claim 8, wherein communication between the first device and the second device is performed only through the GATT channel in the default mode, and
wherein the communication between the first device and the second device is performed through the GATT channel and the CIS channel in the hybrid mode.

10. The method of claim 8, further comprising:
transmitting, to the first device, a second notification message based on the notification based on a specific switch input of the second device, wherein the second notification message is related to the ISO enable instruction,
wherein the first write message is received in response to the second notification message.

11. The method of claim 8, further comprising:
receiving, from the first device, a second write message based on the write without response based on the input of the UI of the first device, wherein the second write message is related to an Isochronous Channel (ISO) disable instruction;
transmitting, to the first device, a third notification message based on the notification, wherein the third notification message is related to an ISO disabled indication; and
terminating communication with the first device through the CIS channel, and performing the communication with the first device through the GATT channel.

12. The method of claim 8, further comprising:
transmitting, to the first device, a fourth notification message based on the notification based on the specific switch input of the second device, wherein the fourth notification message is related to the ISO disable instruction,
wherein the second write message is received in response to the fourth notification message.

13. The method of claim 8, wherein report information is transmitted from the second device to the first device through the CIS channel in the hybrid mode, and
wherein a report interval of the report information is 1 ms.

14. The method of claim 11, wherein when the switching from the hybrid mode to the default mode is performed,
is the report information is transmitted from the second device to the first device through the GATT channel, and
wherein the report interval of the report information is 1 ms or more.

15. A first device in a short-range wireless communication system, the first device comprising:
a first processor corresponding to a host stack;
a second processor corresponding to a controller stack;
a memory;
an input device corresponding to a user interface (UI);
an output device corresponding to the UI; and
a transceiver,
wherein the host stack and the controller stack are connected by a Host Controller Interface (HCI),
wherein the memory stores instructions for performing operations based on being executed by the first processor and the second processor, and
wherein the operations include
receiving a switching input from a default mode to a hybrid mode based on an input of the UI, wherein the first device corresponding to a host and a second device corresponding to a peripheral device are connected through a Generic Attribute Profile (GATT) channel in the default mode;
transmitting, to the second device, a first write message based on a write without response, wherein the first write message is related to an Isochronous Channel (ISO) enable instruction;
receiving, from the second device, a first notification message based on a notification, wherein the first notification message is related to an ISO enabled indication;
performing an ISO enable procedure; and
terminating communication with the second device through the GATT channel, and performing communication with the second device through a Connected Isochronous Stream (CIS) channel.

16. The first device of claim 15, wherein communication between the first device and the second device is performed only through the GATT channel in the default mode, and
wherein the communication between the first device and the second device is performed through the CIS channel in the hybrid mode.

17. The first device of claim 15, wherein the operations further include receiving, from the second device, a second notification message based on the notification based on a specific switch input of the second device, wherein the second notification message is related to the ISO enable instruction, and
wherein the first write message is transmitted in response to the second notification message.

18. The first device of claim 15, wherein the operations further include
receiving a switching input from the hybrid mode to the default mode based on the input of the UI;
transmitting, to the second device, a second write message based on the write without response, wherein the second write message is related to an Isochronous Channel (ISO) disable instruction;
receiving, from the second device, a third notification message based on the notification, wherein the third notification message is related to an ISO disabled indication; and
terminating communication with the second device through the CIS channel, and performing the communication with the second device through the GATT channel.

19. The first device of claim 18, wherein the operations further include
receiving, from the second device, a fourth notification message based on the notification based on the specific switch input of the second device, wherein the fourth notification message is related to the ISO disable instruction, and
wherein the second write message is transmitted in response to the fourth notification message.

20. The first device of claim 15, wherein report information is received from the second device to the first device through the CIS channel in the hybrid mode, and
wherein a report interval of the report information is 1 ms.
